(19) United States
(12) Patent Application Publication
(10) Pub. No.: US 2023/0404063 A1
(43) Pub. Date: Dec. 21, 2023

(54) HUB ASSEMBLY FOR WATERFOWL DECOY DEPLOYMENT SYSTEM

(71) Applicant: QUICKCOYS OUTDOOR PRODUCTS LLC, Macon, MO (US)

(72) Inventor: Keith Beauchamp, Macon, MO (US)

(21) Appl. No.: 18/326,453

(22) Filed: May 31, 2023

Related U.S. Application Data
(60) Provisional application No. 63/353,234, filed on Jun. 17, 2022.

(51) Int. Cl. A01M 31/06

(52) U.S. Cl. CPC A01M 31/06

(57) ABSTRACT

The waterfowl decoy deployment system includes a hub assembly including a central hub and a base coupled to the central hub. The system further includes a motor assembly attached to the base. The motor assembly includes a drive shaft and a propeller coupled to the drive shaft. The drive shaft is rotatable about a rotational axis to propel the hub assembly in a linear direction in an aqueous environment. A plurality of arms are coupled to the central hub and extend radially outward from the central hub.

### CROSS REFERENCE TO RELATED APPLICATIONS

This application claims benefit of U.S. Provisional Patent Application Ser. No. 63/353,234, filed Jun. 17, 2022, the entire contents of which are hereby incorporated by reference in their entirety.

### BACKGROUND

The present disclosure relates generally to hunting decoys, and more particularly to hub assemblies for waterfowl deployment systems, e.g., duck decoy deployment systems.

Most known waterfowl decoy deployment systems are used by hunters to attract waterfowl, such as ducks, so that wild waterfowl are attracted to the decoys and will be brought into shooting range. Many of these known waterfowl decoy deployment systems use submerged components that are spreadable when deploying and collapsible when retrieving. Such known deployment systems typically include a plurality of decoys tethered in some manner to one or more extendable and retractable arms. Many of these known deployment systems experience similar problems.

One such problem is that once the systems are deployed, the decoys do not exhibit natural motion while floating on the surface of the water. For those deployment systems with a plurality of decoys, motion induced through water current and wind patterns does not appear natural to ducks. Also, use of individual motive devices on each individual duck decoy induces decoy motion that also does not appear natural to ducks, since ducks in a group tend to have some degree of synchronization in their movements.

### BRIEF DESCRIPTION

In one aspect, a waterfowl decoy deployment system is provided. The waterfowl decoy deployment system includes a hub assembly defining a longitudinal axis. The hub assembly includes a central hub and a base coupled to the central hub. The base and central hub at least partially define an interior cavity of the central hub. The system further includes a motor assembly attached to the base. The motor assembly includes a drive shaft and a propeller coupled to the drive shaft. The drive shaft is rotatable about a rotational axis to propel the hub assembly in a linear direction in an aqueous environment. The system further includes a plurality of arms coupled to the central hub such that the plurality of arms extends radially outward from the central hub.

In another aspect, a method of assembling a waterfowl decoy deployment system is provided. The method of assembling a waterfowl decoy deployment system includes coupling a base to a central hub of a hub assembly, the hub assembly defining a longitudinal axis. The central hub and the base at least partially define an interior cavity therebetween. The method includes attaching a motor assembly to the base, the motor assembly includes a drive shaft and a propeller coupled to the drive shaft. The drive shaft is rotatable about a rotational axis to propel the hub assembly in a linear direction in an aqueous environment. The method includes coupling a plurality of arms to the central hub such that the plurality of arms extend radially outward from the central hub.

In another aspect, a waterfowl decoy deployment system is provided. The waterfowl decoy deployment system includes a hub assembly defining a longitudinal axis. The hub assembly includes a central hub and a base coupled to the central hub, the base and central hub at least partially defining an interior cavity of the central hub. The hub assembly includes a motor assembly attached to the base. The motor assembly includes a drive shaft and a propeller coupled to the drive shaft, the drive shaft being rotatable about a rotational axis. The motor assembly is positioned relative to the base such that the rotational axis is perpendicular to and intersects the longitudinal axis. The hub assembly further includes a plurality of arms coupled to the central hub such that the plurality of arms extend radially outward from the central hub.

### DRAWINGS

FIGS. 1-19 show example embodiments of the apparatus described herein.

FIG. 1 is a perspective view of an example waterfowl decoy deployment system including a hub assembly and arms in a deployed configuration;

FIG. 2 is a perspective view of the waterfowl decoy deployment system of FIG. 1, showing the arms in a collapsed configuration;

FIG. 3 is a perspective view of a portion of the system of FIG. 1, showing the arms in the collapsed configuration;

FIG. 4 is a top perspective view of the portion of the system shown in FIG. 3, showing the arms in the deployed configuration;

FIG. 5 is a bottom perspective view of the portion of the system shown in FIG. 4;

FIG. 6 is an enlarged perspective view of the hub assembly and portions of the arms shown in FIG. 3;

FIG. 7 is a schematic cross-sectional view of the hub assembly shown in FIG. 6;

FIG. 8 is a perspective view of the hub assembly shown in FIG. 8, showing the hub assembly partially disassembled;

FIG. 9 is a perspective view of a first end of a central hub of the hub assembly shown in FIG. 8;

FIG. 10 is a perspective side view of the central hub shown in FIG. 9;

FIG. 11 is a perspective view of a second end of the central hub shown in FIG. 9;

FIG. 12 is a perspective side view of a hub cap of the hub assembly shown in FIG. 8;

FIG. 13 is a perspective side view of a hub base and motor assembly of the hub assembly shown in FIG. 8;

FIG. 14 is a perspective end view of the hub base and motor assembly shown in FIG. 13;

FIG. 15 is an enlarged perspective view of a portion of the hub base and motor assembly shown in FIG. 13;

FIG. 16 is a perspective view of an example enclosure illustrating an example power source and charging assembly for use with the duck decoy system shown in FIG. 1;

FIG. 17 is another perspective view of the enclosure illustrating the power source and a programming device;

FIG. 18 is a block diagram of a programming device that may be used with the duck decoy system of FIG. 1; and

FIG. 19 is a schematic view showing the duck decoy system deployed in an aqueous environment.

### DETAILED DESCRIPTION

The exemplary methods and apparatus described herein overcome at least some disadvantages of known waterfowl decoy deployment systems by providing a hub assembly that includes a motor assembly which drives or propels decoys to simulate natural duck swimming movements on the surface of the water. Specifically, the motor assembly is attached to a base of the hub and extends below the hub. A propeller of the motor assembly extends below the hub and is controllable to drive the hub in a first direction by a first rotation, or a second, opposed direction by a second rotation. Thus, the hub assembly may be propelled in opposed linear directions in an aqueous environment to simulate animated movement of a grouping of ducks without inducing entanglement of wiring with arms of the system or the motor assembly.

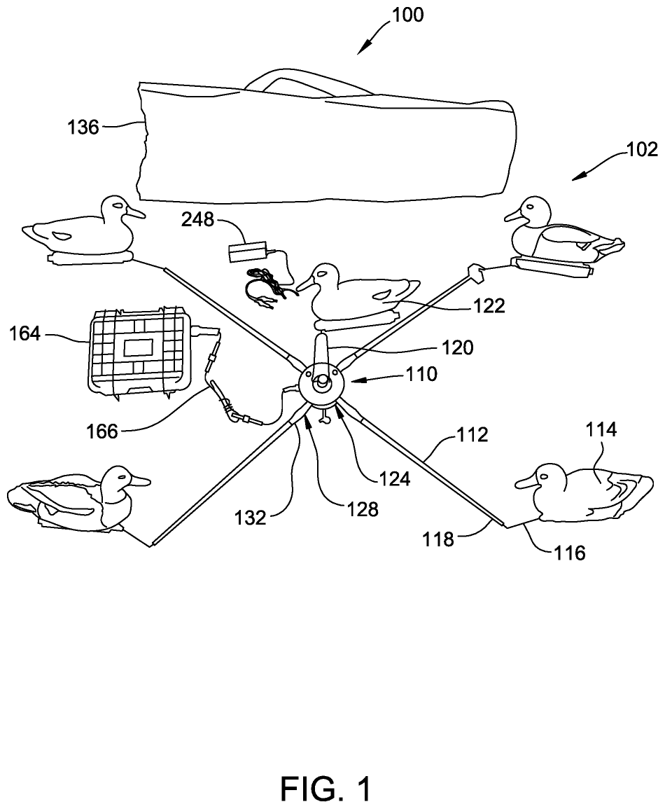

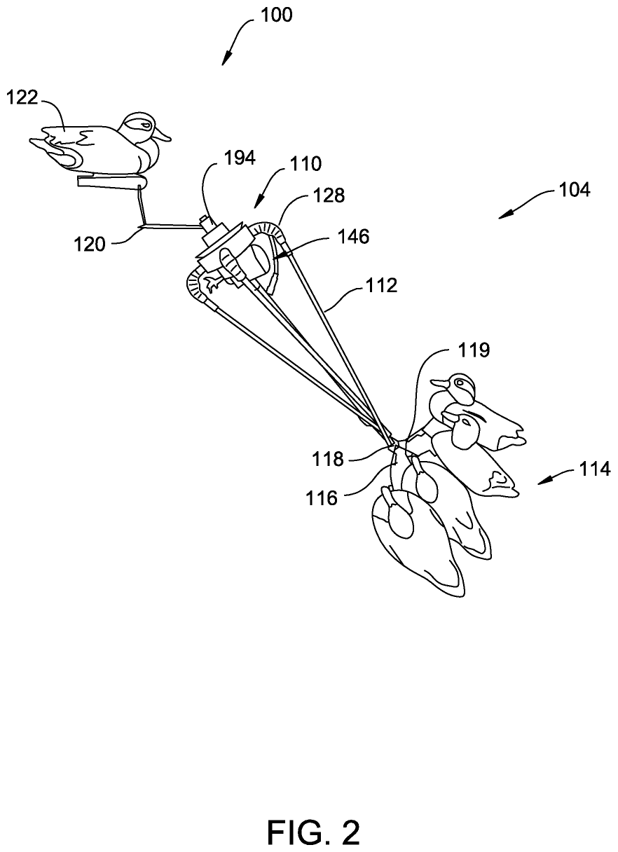

FIG. 1 is a perspective view of an exemplary waterfowl, i.e., duck decoy deployment system 100 in a first or “deployed” configuration 102. FIG. 2 is a perspective view of duck decoy deployment system 100 of FIG. 1 in a second or “collapsed” configuration 104. Alternatively, decoy deployment system 100 is adaptable for any other waterfowl including, without limitation, geese, and swan.

Referring to FIG. 1, duck decoy deployment system 100 includes a hub assembly 110 located substantially at a center portion of system 100. Duck decoy deployment system 100 also includes a plurality of deployably extendable and flexibly collapsible arms 112 coupled to, and extending radially outward from, hub assembly 110 in the deployed configuration 102. In the example embodiment, system 100 includes four arms 112, each having substantially the same length. The arms 112 may have a fixed length or, alternatively, the arms 112 have an adjustable length, e.g., the arms 112 are telescopic. Alternatively, system 100 includes any number of arms 112 having any configuration including, without limitation, different lengths, and materials. Duck decoy deployment system 100 further includes a plurality of decoys 114, e.g., waterfowl, coupled to the arm 112 by a clip 116. In the illustrated embodiment, the decoys 114 are duck decoys 114. In the example embodiment, system 100 includes a duck decoys 114 coupled to distal end 118 of each arm 112. In other embodiments, a plurality of duck decoys 114 may be coupled to one or more of arms 112, such as along different positions along a length of arms 112. Alternatively, system 100 includes any number of duck decoys 114 having any configuration including, without limitation, varying lengths, and materials.

Duck decoy deployment system 100 also includes a wire loop 120 coupled to hub assembly 110 and extending outward therefrom. Wire loop 120 facilitates placement and recovery of system 100 (e.g., as a handle, not shown) in aqueous environments through either hand placement or a hooked rod. Alternatively, any handling device that enables operation of system 100 as described herein is used, including, without limitation, an eye hooks 119 that facilitates placement with a hook device. A central decoy 122 is coupled to wire loop 120 for covering hub assembly 110 (e.g., by floating over a top thereof) when decoy system 100 is placed in aqueous environments.

In the example embodiment, duck decoy deployment system 100 includes a plurality of arm suspension mechanisms, i.e., a spring connectors 128 coupled to hub assembly 110 and a respective arm 112. In the example embodiment, there are four spring connectors 128 positioned approximately 90° apart from each other along circumferential perimeter 124 of hub assembly 110. In general, spring connectors 128 are positioned about circumferential perimeter 124 of hub assembly 110 at circumferential positions of approximately 360 degrees divided by the number of arms 112. As such, hub assembly 110 is substantially symmetrical. Alternatively, hub assembly 110 has any configuration with any number of spring connectors 128 and arms 112 that enable operation of system 100 as described herein.

Spring connectors 128 each include a biasing device 132 that extends between arms 112 and hub assembly 110. In the example embodiment, biasing devices 132 includes a constant-pitch, variable-diameter, constant-rate (i.e., a substantially non-varying spring constant with a predefined linearity) helical compression spring mechanism, or spring. In particular, in the example embodiment, spring connectors 128 are substantially similar to spring adaptor assembly, described in U.S. Patent Application Publication No. 2019/0254272, the entire contents of which are hereby incorporated by reference. Alternatively, biasing devices 132 are any devices that enable operation of duck decoy deployment system 100 as described herein, including, without limitation, biased hinge devices, variable- and multiple-pitch springs, constant-diameter springs (i.e., conical springs), and multiple rate springs.

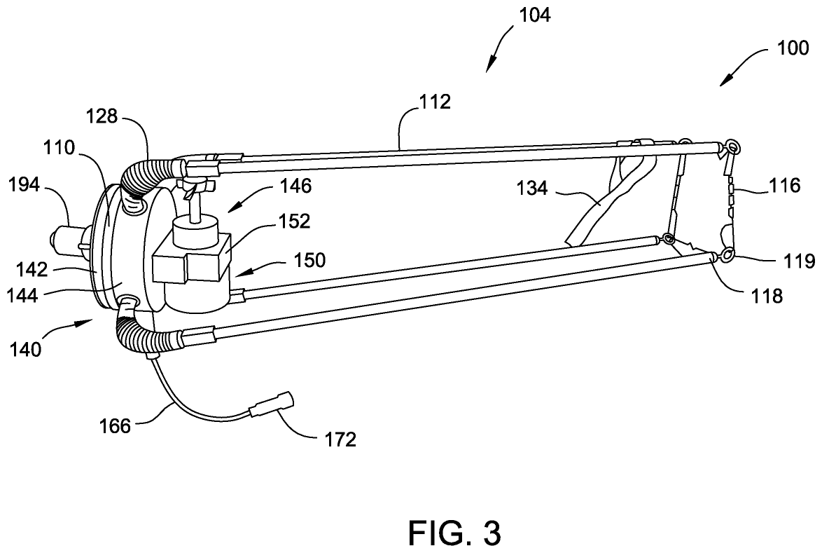

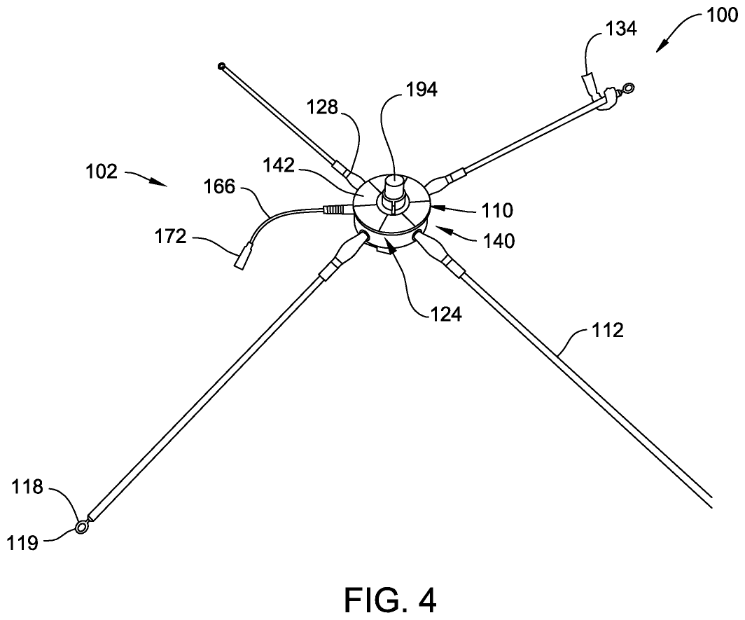

In the example embodiment, spring connectors 128, and more specifically, biasing devices 132 of spring connectors 128, bias each of the arms 112 radially outward from hub assembly 110 to the deployed configuration 102, as shown in FIG. 1. System 100 may be moved to the collapsed configuration 104, as shown in FIG. 2, by bending the arms 112 inwards towards the hub assembly 110 and towards the other arms 112, against the biasing force of biasing devices 132. Referring to FIG. 2, at least one of arms 112 includes a releasable strap 134 coupled thereto, proximate to distal end 118 of the arm 112. In the example embodiment, strap 134 is a Velcro® strap that is sized to extend around each of arms 112 in the collapsed configuration 104 and secure arms 112 in the collapsed configuration 104, as shown in FIG. 2. The strap 134 may be any suitable strap having any suitable fasteners, e.g., buttons, clasps, and/or buckles, such that the strap 134 may be used to selectively secure the arms 112 in the collapsed configuration 104. Clips 116 connecting decoys 114 to arms 112 may additionally or alternatively be used to secure arms 112 in the collapsed configuration 104, see FIG. 3. In some embodiments, decoys 114 may be decoupled from arms 112 prior to stowing decoy deployment system 100 in a case 136 and clips 116 may be used to secure each of arms 112 in the collapsed configuration 104 (e.g., as shown in FIG. 4).

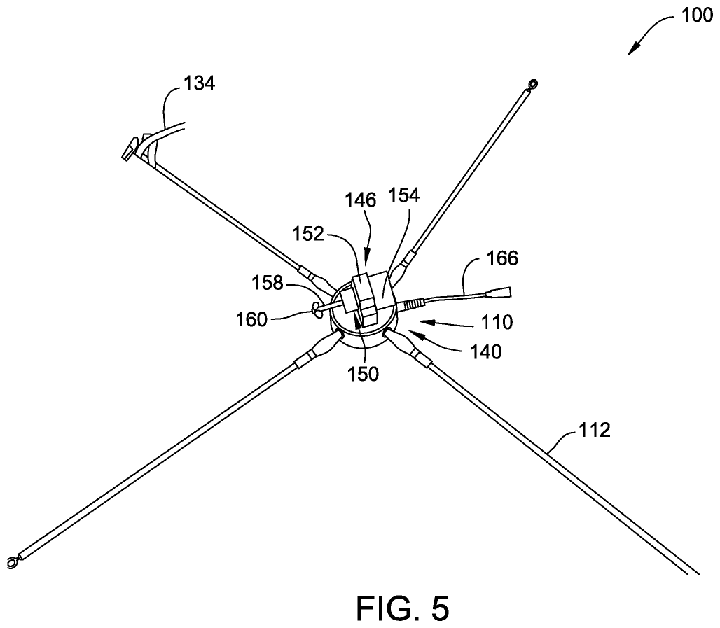

FIG. 3 is a side view of a portion of decoy system 100 shown in FIG. 1, showing arms 112 in the collapsed configuration 104. FIG. 4 is a top perspective view of the portion of decoy system 100 shown in FIG. 3. FIG. 5 is a bottom perspective view of the portion of decoy system 100 shown in FIG. 4. In FIGS. 3-5 decoys 114, wire loop 120, control assembly 164 and wiring 166 are not shown for clarity.

Referring to FIG. 3, hub assembly 110 includes a central hub 140, a hub cap 142, a hub base 144, and a motor assembly 146. Motor assembly 146 includes a motor housing 150 that is coupled to hub base 144 by a motor bracket 152. In particular, in the example embodiment, motor bracket 152 extends around motor assembly 146 and is fixedly attached (e.g., by screw fasteners 224 described below) to hub base 144. In other embodiments, motor assembly 146 may be coupled to hub assembly 110 in any other suitable manner that enables decoy system 100 to function as described herein.

Motor housing 150 houses a motor 154 therein that is coupled to a drive shaft 158 and a propeller 160, as shown in FIG. 5. Motor 154 receives electrical energy from a power source 162 of control assembly 164 (shown in FIG. 1) via wiring 166 such that motor 154 rotates propeller 160 according to a predetermined mode of operation. In the exemplary embodiment, motor 154 is a sealed marine motor. For example, motor 154 may be 12 volt or 5-amp motor that is powered by power source 162. Furthermore, as described herein, motor 154 is a reverse polarity motor that is able to rotate drive shaft 158 in two directions (i.e., clockwise and counterclockwise) based on a desired operating mode.

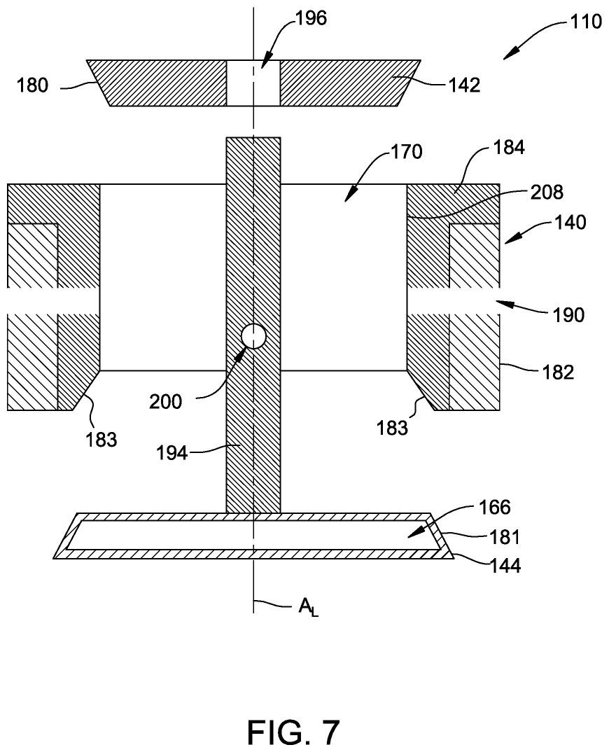

Hub assembly 110 further defines an interior cavity 170 (shown in FIG. 7). Wiring 166 extends through an opening (not shown) in central hub 140 of hub assembly 110, into interior cavity 170, and to motor 154. Wiring 166 includes a watertight connector 172 for connecting wiring 166 to wiring of control assembly 164 (shown in FIG. 1). As shown in FIGS. 4 and 5, wiring 166 extends radially outward from central hub 140 to connector 172 at a circumferentially opposed side of central hub 140 as propeller 160 to reduce potential of interference between propeller 160 and wiring 166.

Referring to FIGS. 3 and 4, in the example embodiment, arms 112 each include the eye hooks 119 positioned at distal ends 118 of arms 112. Clips 116 extend through eye hooks 119 for connecting decoys 114 at distal ends 118 of arms 112 (e.g., as shown in FIG. 1) and may alternatively be used to couple distal ends 118 of arms 112 to one another (e.g., as shown in FIG. 3) in the collapsed configuration 104. In other embodiments, arms 112 may include any suitable coupler that enables decoys 114 to be coupled to arms 112.

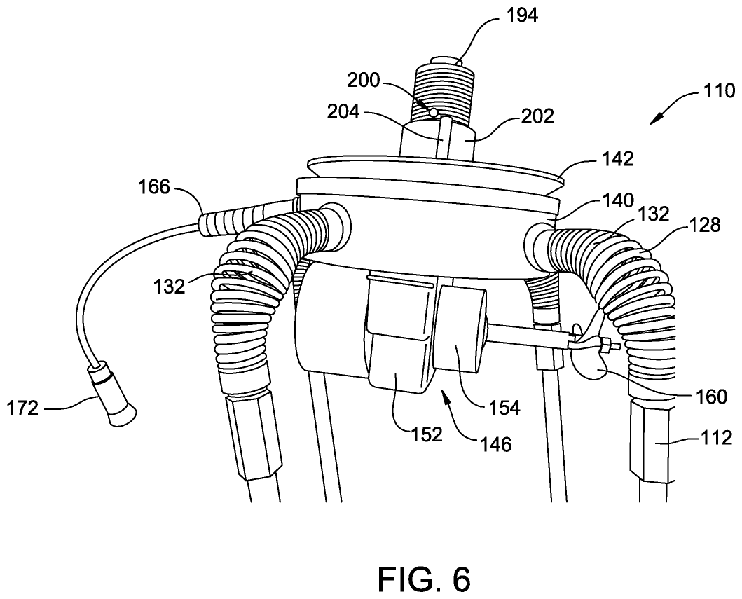

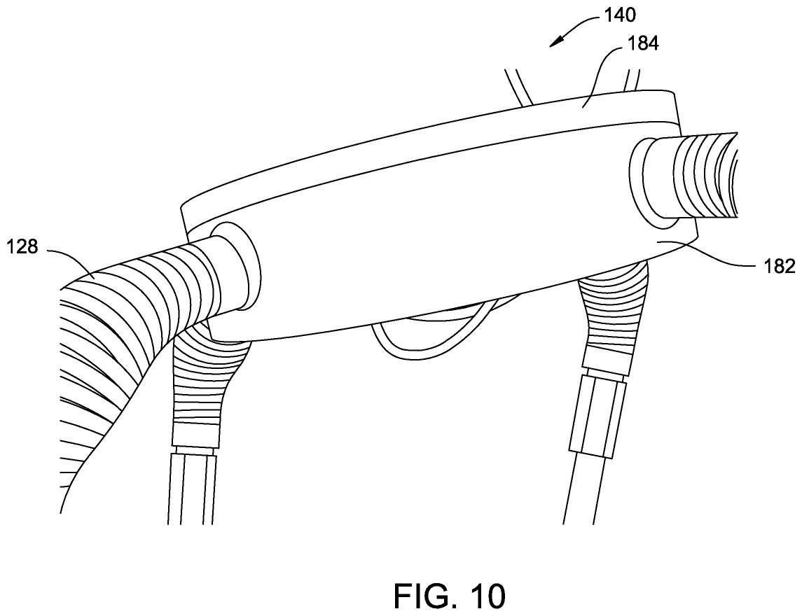

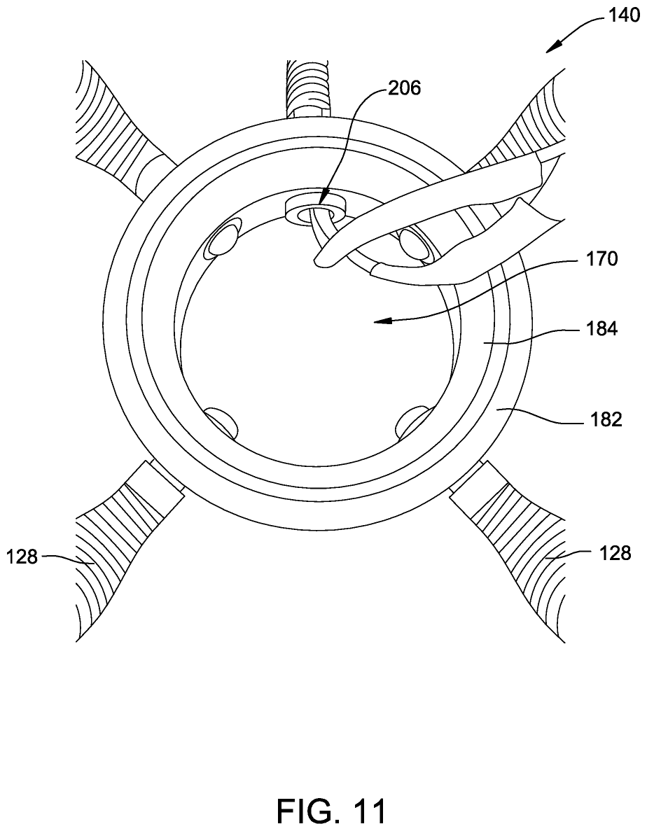

FIGS. 6-15 show portions of hub assembly 110 and motor assembly 146. In particular, FIG. 6 is a perspective view of hub assembly 110 and motor assembly 146. FIG. 7 is a schematic exploded view of hub assembly 110.

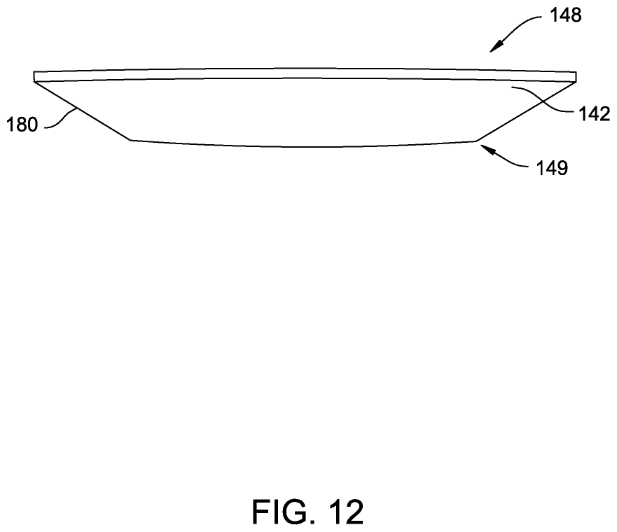

In the example embodiment, hub assembly 110 includes hub base 144, hub cap 142, and central hub 140. Hub assembly 110 defines a longitudinal axis, as shown in FIG. 7. Hub base 144 and hub cap 142 are positioned on longitudinally opposed ends of central hub 140. Central hub 140 includes an outer body 182 and a sealing body 184 provided within outer body 182. Hub cap 142 and hub base 144 each have a generally circular profile and include tapered peripheral surfaces 180, 181 that taper laterally outward at the longitudinally opposed ends of central hub 140. The cap 142 comprises a first tapered surface 180 that tapers laterally outward in a longitudinal direction extending away from the base 144 (i.e., from the bottom to the top of the page along the longitudinal axis A_{L} in FIG. 7). The base 144 includes a second tapered surface 181 that tapers laterally inward in the longitudinal direction. The central hub 140, and more specifically, the sealing body 184 of central hub 140 further includes a third tapered surface 183 at a lower end of central hub 140 that tapers laterally inward in the longitudinal direction and is tapered in correspondence with the second tapered surface 181. The first tapered surface 180 extends around a circumferential periphery of the cap 142, the second tapered surface 181 extends around a circumferential periphery of the base 144, and the third tapered surface 183 extends around circumferential periphery of the central hub. When assembled, hub cap 142 and hub base 144 each engage and seal against sealing body 184, with the second tapered surface 181 engaged with and contacting the third tapered surface 183 of the central body. The hub cap 142 include an upper side 148 and a lower side 149, see FIG. 12.

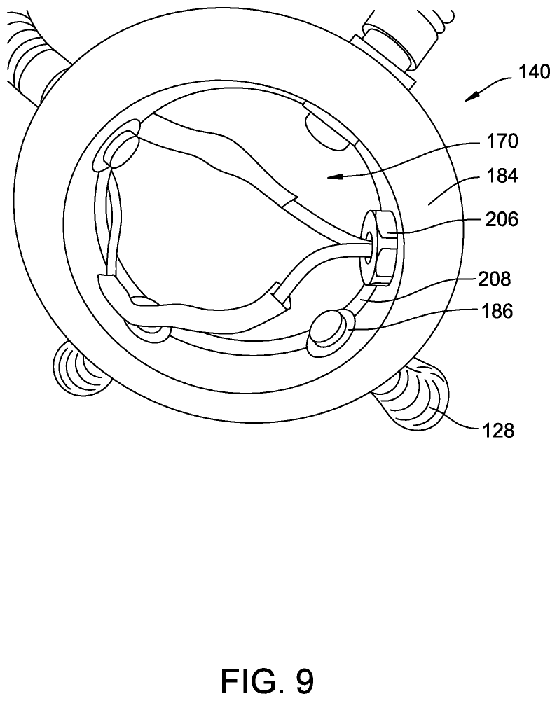

In the example embodiment, sealing body 184 and outer body 182 each define spring apertures 190 of central hub 140 for receiving spring connectors 128 therethrough. In particular, as shown in FIG. 9, spring connectors 128 include spring fasteners 186 which extend through spring apertures 190 and secure spring connectors 128 on an interior surface 188 of sealing body 184. Outer body 182 has a structural rigidity or stiffness that is greater than a structural rigidity of the resilient portion to provide an enhanced structural integrity of central hub 140 and limit strain and stress on sealing body 184 induced by spring connectors 128, or more specifically biasing forces of spring connectors 128. In the example embodiment outer body 182 is made of Polyvinyl chloride (“PVC”) and sealing body 184 is made of rubber, though in other embodiments, other suitable materials may be used.

Referring back to FIGS. 6 and 7, hub assembly 110 further includes a threaded central shaft 194 coupled to hub base 144 that extends through the interior cavity 170 of central hub 140 and through a shaft aperture 196 defined in hub cap 142. Central shaft 194 may be fixedly attached and/or unitarily formed with hub base 144. Central shaft 194 further includes a hole 200 defined therein for receiving wire loop 120. A shaft fastener 202 includes corresponding threaded tracks on an interior surface (not shown) of the shaft fastener 202. The shaft fastener 202 further includes wings 204 which extend radially outward from the shaft fastener 202. The wings 204 may be used to grip the shaft fastener 202 during rotations of the shafter fastener 202, which is threadably engaged with the threaded central shaft 194.

To assemble hub assembly 110, central hub 140 is positioned on hub base 144 and hub cap 142 is positioned over central hub 140 with central shaft 194 extending through shaft aperture 196. Shaft fastener 202 is then threaded onto central shaft 194 and until the shaft fastener 202 contacts hub cap 142. Shaft fastener 202 is then tightened to press and seal hub cap 142 and hub base 144 against sealing body 184 of central hub 140. The shaft fastener 202 may be tightened using the wings 204. In the example embodiment, hole 200 is defined at a longitudinal position on central shaft 194 such that, when fastener is tightened to be below hole 200 (e.g., as shown in FIG. 6) hub cap 142 and hub base 144 are each provided in a tight seal with central hub 140. Accordingly, hole 200 provides a visual indication during assembly that shaft fastener 202 is sufficiently tightened and the user may insert wire loop 120 into hole 200.

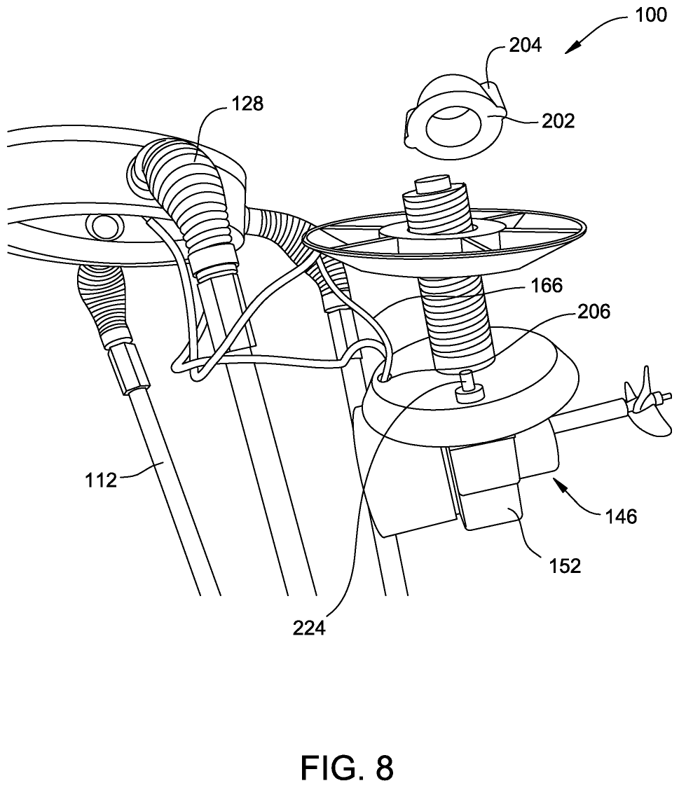

Referring to FIGS. 8-14, central hub 140 defines an internal wiring opening 206 on an inner surface 208 of central hub 140 or, more specifically in the example embodiment, on an inner surface 208 of sealing body 184. Wiring 166 extends through the wire opening 206, into the interior cavity 170 of hub assembly 110. As shown in FIGS. 7, 8, and 13, hub base 144 is generally hollow and defines a wiring cavity therein. Wiring 166 within the interior cavity 170 of hub assembly 110 extends through wire opening 206, into cavity 170 of hub base 144, and out of the hub base 144 and into the motor housing 150.

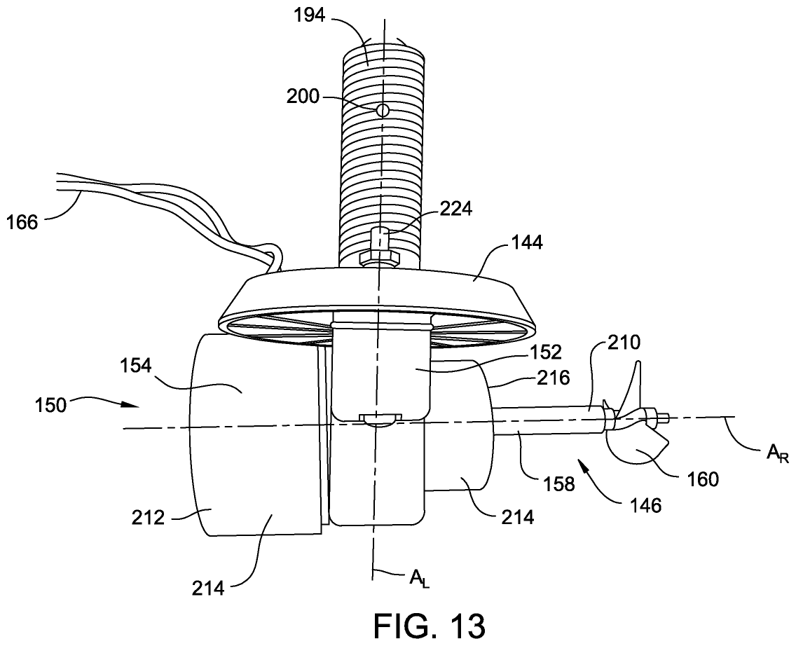

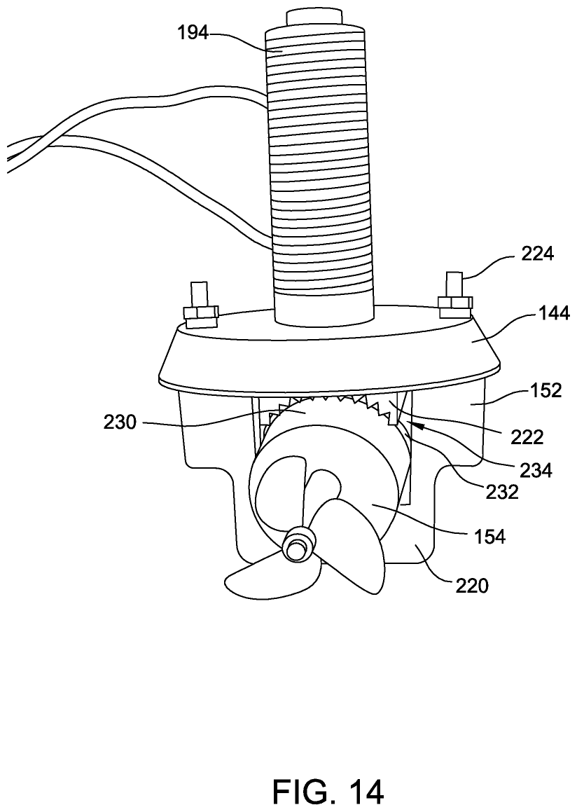

Referring to FIGS. 13 and 14, in the example embodiment, the drive shaft 158 extends (i.e., generally perpendicular to the longitudinal axis) from the motor housing 150, and the propeller 160 coupled to a distal end 210 of the drive shaft 194. Motor 154 is operable to rotate drive shaft 158 and propeller 160 about a rotational axis A_{R} that is generally perpendicular to the longitudinal axis A_{L}.

The motor assembly 146 is coupled to the hub assembly 110 (shown in FIG. 6) such that the longitudinal axis A_{L} of the hub assembly 110 intersects the rotational axis A_{R} of the drive shaft 158 at approximately a ninety-degree angle. The motor assembly 146 is positioned directly below the hub base 144 such that, at least a portion of the motor housing 150 and drive shaft 158 are positioned to be longitudinally overlapped within a circumferential periphery (e.g., as defined by a lower extent of the second tapered wall 181, shown in FIG. 7) of the hub base 144. The propeller 160 is laterally offset from the hub base 144 (i.e., positioned radially outside of the hub base 144). Rotation of the propeller 160 drives the hub assembly 110 (when in an aqueous environment) in a linear direction along a directional axis colinear with the rotational axis A_{R}. Linear may refer to a straight line, e.g., along the surface of the water. Movement of the hub assembly 110, in a linear direction, pulls the decoys 114 in a straight line. Movement of the hub assembly 110, in a linear direction pulls all of the decoys 114 in a straight line such that a path of all the decoys 114 are parallel. The arrangement of the hub assembly 110 and the arms 112 pulling the duck decoys 114 causes the duck decoys 114 to appear to be moving in the same direction, e.g., a head of the duck decoys 114 is facing the direction of motion of the hub assembly 110.

Motor housing 150 includes a first circumferential portion 212 and a second circumferential portion 214 having a diameter smaller than the first circumferential portion 214. Drive shaft 158 extends outward from an end surface 216 of second circumferential portion 214. Motor bracket 152 is attached to and extends around second circumferential portion 214. A pair of fasteners 224 (e.g., including a nut and bolts in the example embodiment) extend through the motor bracket 152 and through the hub base 144 to secure motor 154 in position on hub base 144.

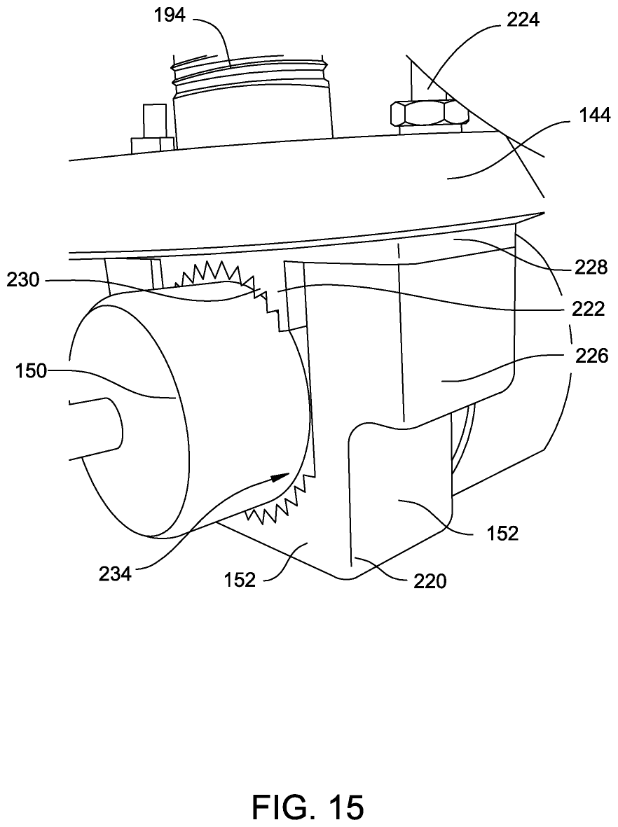

Referring to FIGS. 14 and 15, motor bracket 152 includes an outer clamp 220 and an inner clamp 222. The outer clamp 220 is coupled to hub base 144 by the fasteners 224 extending through hub base 144. Specifically, fasteners 224 extend through ledge portions 226 of outer clamp 220 and a base portion 228 of inner clamp 222. In other embodiments, outer clamp 220 and inner clamp 222 may be separately coupled to hub base 144. Outer clamp 220 and inner clamp 222 cooperatively clamp motor housing 150 in a bracket cavity 234 defined therebetween. In the example embodiment, outer clamp 220, and inner clamp 222 each define a plurality of teeth 230 facing inward toward the bracket cavity 234. A cushion 232 is positioned between motor housing 150 and the clamps 220, 222. In the example embodiment the cushion 232 is formed of a foam material, though in other embodiments, the cushion 232 may be formed of any suitable material.

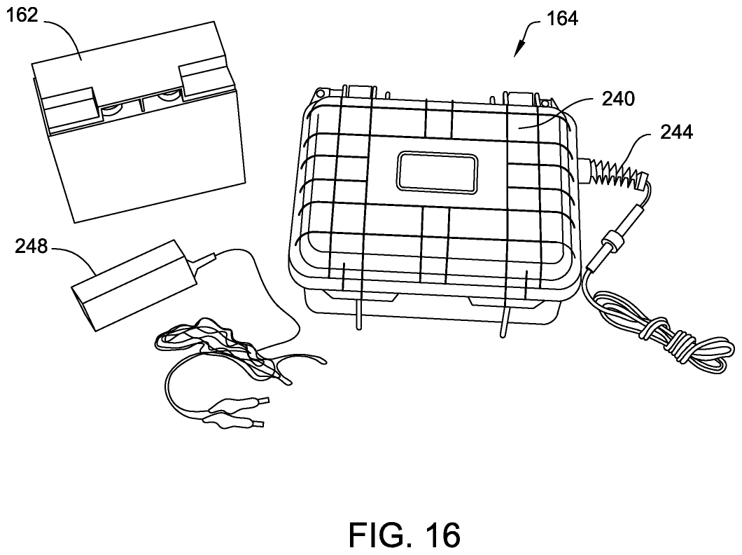

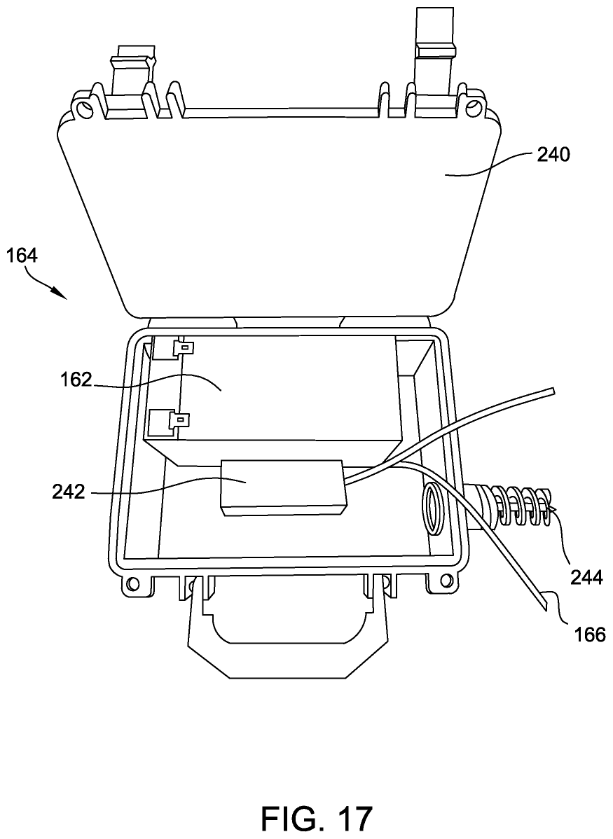

FIGS. 16-18 show the control assembly 164 of duck decoy system 100, shown in FIG. 1. In the example embodiment, control assembly 164 includes an enclosure 240 that houses the power source 162 for providing power to motor 154 and also a programming device 242 for controlling operation of motor 154. A power cord 244 is provided which couples power source 162 in electrical communication with motor 154 via the wiring 166 and connector 172 of hub assembly 110, as described above.

In the example embodiment, power source 162 may be a sealed, waterproof, rechargeable battery that is positioned within enclosure 240 and located beneath a water line 246 such that power source 162 and enclosure 240 are submerged. Power source 162 may be a lead-acid battery, a nickel-cadmium battery, a lithium-ion battery, or any type of battery that enables operation of motor assembly 146 as described herein. For example, power source 162 may include the follow specifications: 12 volts DC Nominal Voltage; 18 Ampere-hours (AH) of Nominal Capacity at a 20-hour rate; 13.5-13.8 volts of direct current (VDC) on standby; 14.4-15.0 VDC during cycle use; initial current of 0.1 Coulombs per second (C). Alternatively, power source 162 includes any operating specifications that facilitate operation of motor assembly 146 as described herein. In another embodiment, at least one of power source 162 and/or programming device are provided within the interior cavity 170 of hub assembly 110. In such embodiments, the enclosure 240 may not be provided and duck decoy system 100 may be anchored using another suitable anchor or may be free floating (i.e., without the use of an anchor). System 100 may further include a charging assembly 248 that may be used to recharger power source 162.

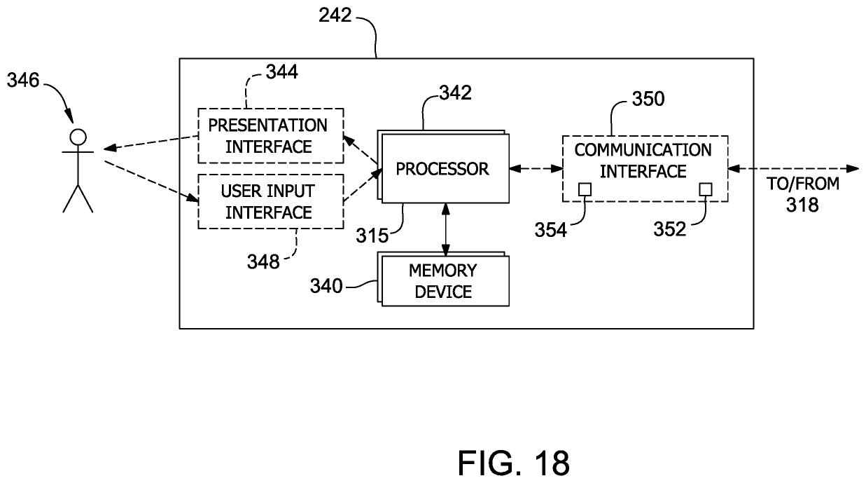

FIG. 18 is a block diagram of motor programming device 242 that may be used with motor assembly 146. Motor programming device 242 includes at least one memory device 340 and a processor 342 that is coupled to memory device 340 for executing instructions. In some embodiments, executable instructions are stored in memory device 340. In the example embodiment, motor programming device 242 performs one or more operations described herein by programming processor 342. For example, processor 342 may be programmed by encoding an operation as one or more executable instructions and by providing the executable instructions in memory device 340.

Processor 342 may include one or more processing units (e.g., in a multi-core configuration). Further, processor 342 may be implemented using one or more heterogeneous processor systems in which a main processor is present with secondary processors on a single chip. As another illustrative example, processor 342 may be a symmetric multi-processor system containing multiple processors of the same type. Further, processor 342 may be implemented using any suitable programmable circuit including one or more systems and microcontrollers, microprocessors, reduced instruction set circuits (RISC), application specific integrated circuits (ASIC), programmable logic circuits, field programmable gate arrays (FPGA), and any other circuit capable of executing the functions described herein. In the example embodiment, processor 342 controls operation of motor 154.

In the example embodiment, memory device 340 is one or more devices that enable information such as executable instructions and/or other data to be stored and retrieved. Memory device 340 may include one or more computer readable media, such as, without limitation, dynamic random-access memory (DRAM), static random-access memory (SRAM), a solid-state disk, and/or a hard disk. Memory device 340 may be configured to store, without limitation, application source code, application object code, source code portions of interest, object code portions of interest, configuration data, execution events and/or any other type of data. In the example embodiment, memory device 340 includes firmware and/or initial configuration data for motor 154.

In the example embodiment, motor programming device 242 includes a presentation interface 344 that is coupled to processor 342. Presentation interface 344 presents information, such as an application menu and/or execution events, to a user 346. For example, presentation interface 344 may include a display device, such as a cathode ray tube (CRT), a liquid crystal display (LCD), an organic LED (OLED) display, and/or an “electronic ink” display. In some embodiments, presentation interface 344 includes one or more display devices.

In the example embodiment, motor programming device 242 includes a user input interface 348 that is coupled to processor 342 and receives input from user 346. User input interface 348 may include, for example, a keyboard, a pointing device, a mouse, a stylus, and/or a touch sensitive panel (e.g., a touch pad or a touch screen). A single component, such as a touch screen of a mobile device (e.g., a smartphone or tablet computer), may function as both a display device of presentation interface 344 and user input interface 348.

Motor programming device 242 includes a communication interface 350 coupled to processor 342. Communication interface 350 communicates with one or more remote devices, such as motor. In the example embodiment, communication interface 350 includes a wireless communications module 352 that enables wireless communication and a signal converter 354 that converts wireless signals received by wireless communications module 352. For example, in one embodiment, signal converter 354 converts a motor configuration data signal into a radio signal for transmission to an antenna (not shown) on motor. In another embodiment, signal converter 354 coverts a received radio signal from motor into motor diagnostic data for analyzing operations of motor.

In the example embodiment, programming device 242 is configured to control operation of motor. As described above, in some embodiments programming device 242 communicates wirelessly with presentation interface 344 and user input interface 348 and with motor to operate motor in accordance with a predetermined operating mode. In other embodiments, programming device 242 is physically coupled to motor through wiring 166 and only communicates wirelessly with presentation interface 344 and user input interface 348 to control motor. As described above, presentation interface 344 and user input interface 348 may include a single device, such as, but not limited to a smartphone or tablet.

In operation, power source 162 and programming device 242 are activated to provide power and operating instructions to motor. As described herein, motor is coupled to hub assembly 110 and rotates a drive shaft 158 and propeller 160 about a rotational axis in either a clockwise or a counterclockwise direction. In such a configuration, for example, programming device 242 is programmed to switch polarities of motor, such that propeller 160 is rotating in a first rotational direction (e.g., a clockwise rotation) for a first predetermined period of time and a second opposite rotational direction (e.g., a counterclockwise rotation) for a second predetermined period of time.

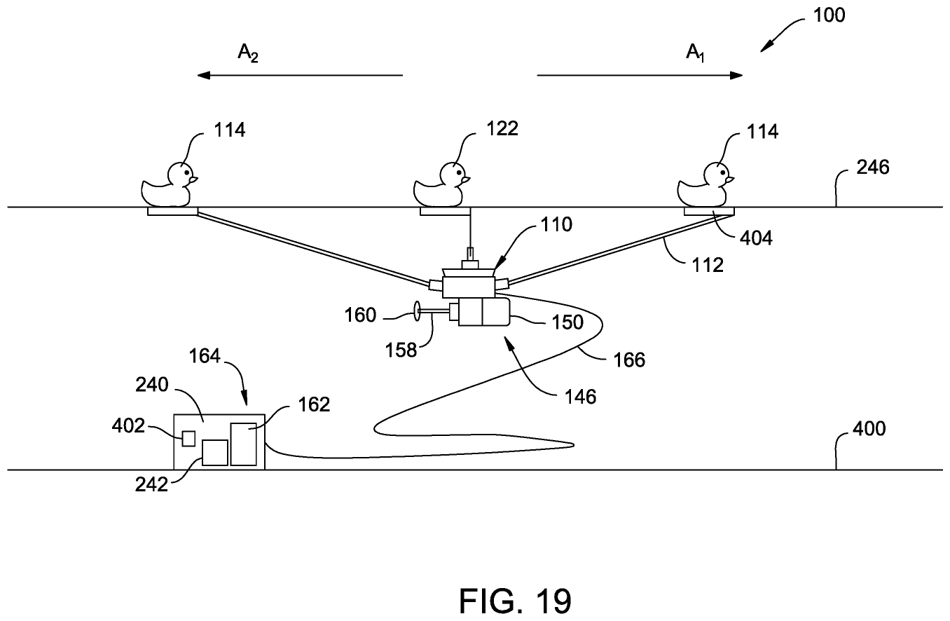

FIG. 19 is a schematic side view of duck decoy system 100 deployed in an aqueous environment. In particular, during operation enclosure 240 assembly, hub assembly 110, and arms 112 are carried by a user into the water environment and control assembly 164 is submerged below the water line 246, anchoring the decoy system 100 on a bed 400, such as a lakebed or riverbed. When the duck decoy system 100 is deployed in the water environment, the decoys 114, 122 may float on top of the water. The decoys 114, 122 may include a keel 404 to keep the decoys upright as the decoys float on the water. Control assembly 164 includes a switch 402 provided on an exterior of enclosure 240, which the user switches the switch 402 to the on position, to supply power to motor assembly 146 and initiate operation of motor 154.

In the example embodiment, programming device 242 automatically controls the polarity of current flow from power source 162 to motor 154 for a predetermined, programmed duration for each polarity in a repeatable sequence to control the direction of rotation of drive shaft 158 and propeller 160 to control the direction of propulsion of motor assembly 146. Programming device 242 operates motor 154 for a first duration, such as 4-6 seconds, at a first respective polarity to drive hub assembly 110 and decoys 114 in a first direction A₁. Then, optionally, programming device 242 stops operation of motor 154 for a second duration (e.g., 10 seconds), and then operates motor 154 for a third duration (e.g., 4-6 seconds) at a second respective polarity to drive hub assembly 110 and decoys 114 in the direction A₂, substantially opposite the direction A₁. The programming device 242 controls motor 154 to propel hub assembly 110 and decoys 114 in the forward direction A₁ for any predetermined period of time, and then back in the reverse direction A₂ for any predetermined period of time. The predetermined times may be at least in part based on a length of the wiring 166 and to limit an amount of time driving the motor 154 with the wiring 166 in tension. Programming device 242 may then repeat the entire sequence a predetermined number of times or for a predetermined duration. In the example embodiment, the duration of each step in the sequence is adjustable by user 346 via programming device 242 as environmental conditions warrant. Rotating motor assembly 146 in different directions not only reduces the potential for entanglement of wiring 166 and or destabilizing forces on the system 100 when the wiring 166 is in tension during operation, but also emulates natural duck motion as described herein.

Example embodiments of a hub assembly 110 for a waterfowl decoy deployment system 100 are described above in detail. The hub assembly 110 is not limited to the specific embodiments described herein, but rather, components of the apparatus may be utilized independently and separately from other components described herein. For example, the features of the hub assembly 110 for a waterfowl decoy deployment system 100 described herein may also be used in combination with other deployment systems that call for rapid and easy deployment and recovery.

Although specific features of various embodiments of the disclosure may be shown in some drawings and not in others, this is for convenience only. In accordance with the principles of the disclosure, any feature of a drawing may be referenced and/or claimed in combination with any feature of any other drawing.

This written description uses examples to disclose the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A waterfowl decoy deployment system comprising:
a hub assembly defining a longitudinal axis, the hub assembly comprising:
a central hub;
a base coupled to the central hub, the base and central hub at least partially defining an interior cavity of the central hub; and
a motor assembly attached to the base, the motor assembly including a drive shaft and a propeller coupled to the drive shaft, the drive shaft being rotatable about a rotational axis to propel the hub assembly in a linear direction in an aqueous environment; and
a plurality of arms coupled to the central hub such that the plurality of arms extends radially outward from the central hub.

2. The waterfowl decoy deployment system of claim 1, wherein the motor assembly is positioned relative to the base such that the rotational axis is perpendicular to and intersects the longitudinal axis.

3. The waterfowl decoy deployment system of claim 1, wherein the base includes an inner surface at least partially defining the interior cavity and an opposed outer surface, wherein the motor assembly is attached to the base on the outer surface.

4. The waterfowl decoy deployment system of claim 1, wherein the hub assembly further comprises:
a central shaft coupled to the base and extending longitudinally therefrom; and
a cap coupled to the central shaft, wherein the cap and the base are positioned at opposed longitudinal ends of the hub assembly.

5. The waterfowl decoy deployment system of claim 4, wherein the central shaft is a threaded shaft and wherein the hub assembly further comprises a fastener that engages the threaded shaft to urge the cap into contact with the central hub.

6. The waterfowl decoy deployment system of claim 5, wherein the cap is positioned longitudinally between the fastener and the central hub.

7. The waterfowl decoy deployment system of claim 4, wherein the cap comprises a first tapered surface that tapers laterally outward in a longitudinal direction extending away from the base.

8. The waterfowl decoy deployment system of claim 7, wherein the base comprises a second tapered surface that tapers laterally inward in the longitudinal direction.

9. The waterfowl decoy deployment system of claim 8, wherein the central hub comprises a third tapered surface that is configured to contact the second tapered surface of the base, the third tapered surface being tapered in correspondence with the second tapered surface.

10. The waterfowl decoy deployment system of claim 9, wherein the first tapered surface extends around a circumferential periphery of the cap, the second tapered surface extends around a circumferential periphery of the base, and the third tapered surface extends around circumferential periphery of the central hub.

11. The waterfowl decoy deployment system of claim 1, wherein the central hub includes an outer body portion and a sealing body, the sealing body being positioned on a radially interior surface of the outer body portion, the outer body portion having a structural rigidity that is greater than the sealing body.

12. The waterfowl decoy deployment system of claim 11, wherein the sealing body defines an inner surface of the central hub, wherein the hub assembly further comprises:
a central shaft coupled to the base and extending longitudinally therefrom; and
a cap coupled to the central shaft, and wherein the inner surface, the hub, and the cap collectively define the interior cavity.

13. The waterfowl decoy deployment system of claim 11, wherein the outer body portion and the sealing body each define a plurality of apertures positioned in correspondence to facilitate inserting a spring connector through the central hub and at least partially into the interior cavity.

14. The waterfowl decoy deployment system of claim 1 further comprising a bracket attaching the motor assembly to the base, the bracket comprising an outer clamp, an inner clamp, and a fastener extending through the outer clamp, the inner clamp, and the base, the outer clamp and inner clamp defining a cavity therein sized to receive at least a portion of the motor assembly.

15. The waterfowl decoy deployment system of claim 1, wherein at least a portion of the motor housing is positioned to be longitudinally overlapped with the base and the propeller is laterally offset from the base.

16. A method of assembling a waterfowl decoy deployment system comprising:
coupling a base to a central hub of a hub assembly, the hub assembly defining a longitudinal axis, wherein the central hub and the base at least partially define an interior cavity therebetween;
attaching a motor assembly to the base, the motor assembly including a drive shaft and a propeller coupled to the drive shaft, the drive shaft being rotatable about a rotational axis to propel the hub assembly in a linear direction in an aqueous environment; and
coupling a plurality of arms to the central hub such that the plurality of arms extend radially outward from the central hub.

17. The method of claim 16, wherein the motor assembly is positioned relative to the base such that the rotational axis is perpendicular to and intersects the longitudinal axis.

18. The method of claim 16, wherein the base includes an inner surface at least partially defining the interior cavity and an opposed outer surface, wherein the motor assembly is attached to the base on the outer surface.

19. The method of claim 16 further comprising:
coupling a central shaft to the base such that the central shaft extends longitudinally from the base within the interior cavity; and
coupling a cap to the central shaft at an opposed longitudinal end of the hub assembly from the base.

20. A waterfowl decoy deployment system comprising:
a hub assembly defining a longitudinal axis, the hub assembly comprising:
a central hub;
a base coupled to the central hub, the base and central hub at least partially defining an interior cavity of the central hub; and
a motor assembly attached to the base, the motor assembly including a drive shaft and a propeller coupled to the drive shaft, the drive shaft being rotatable about a rotational axis, wherein the motor assembly is positioned relative to the base such that the rotational axis is perpendicular to and intersects the longitudinal axis; and
a plurality of arms coupled to the central hub such that the plurality of arms extend radially outward from the central hub.
